(19) United States
(12) Patent Application Publication
(10) Pub. No.: US 2006/0170399 A1
(43) Pub. Date: Aug. 3, 2006

(54) Power factor controller utilizing duel-switch configuration

(75) Inventor: John Griffin, Morton Grove, IL (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/545,844

(22) PCT Filed: Dec. 12, 2003
(86) PCT No.: PCT/IB03/06044

§ 371 Date: Aug. 17, 2005

Related U.S. Application Data
(60) Provisional application No. 60/435,229, filed on Dec. 20, 2002.

(51) Int. Cl. G05F 1/613; G05F 3/16

(52) U.S. Cl. 323/225

(57) ABSTRACT

An apparatus is directed to regulating a step down voltage across a load. The apparatus includes a regulator circuit (210, 310) arranged to couple power from an unregulated power supply V(+) to the load V(Out) in response to a control signal. The apparatus further includes a power control circuit (220, 320) arranged to selectively couple power from the unregulated power supply V(+) to the regulator circuit (210, 310) when activated by the control signal. The regulator circuit (210, 310) may be implemented as a boost regulator circuit. The control signal may be received as a periodic control signal. The power control circuit (220, 320) may include a switch circuit (SW, SW1) arranged to selectively couple power from the unregulated power supply V(+) to the regulator (210, 310) when activated by the control signal, and a diode circuit (D, D2) arranged in parallel to the regulator circuit. The switch circuit (SW, SW1) may be implemented as a MOSFET or a BJT.

In general, the invention relates producing a regulated voltage output. More specifically, the invention relates to an apparatus and method for producing a regulated voltage output with a reduced power factor input.

Switching regulators include many unusual properties that have made them popular. For example, switching regulators can be very efficient because there is usually very little power dissipation, acceptable power factor correction, and low harmonic distortion. Additionally, switching regulators can generate output higher than the unregulated input. Switching regulators are utilized as small, lightweight, and efficient dc supplies and are utilized almost universally in computers.

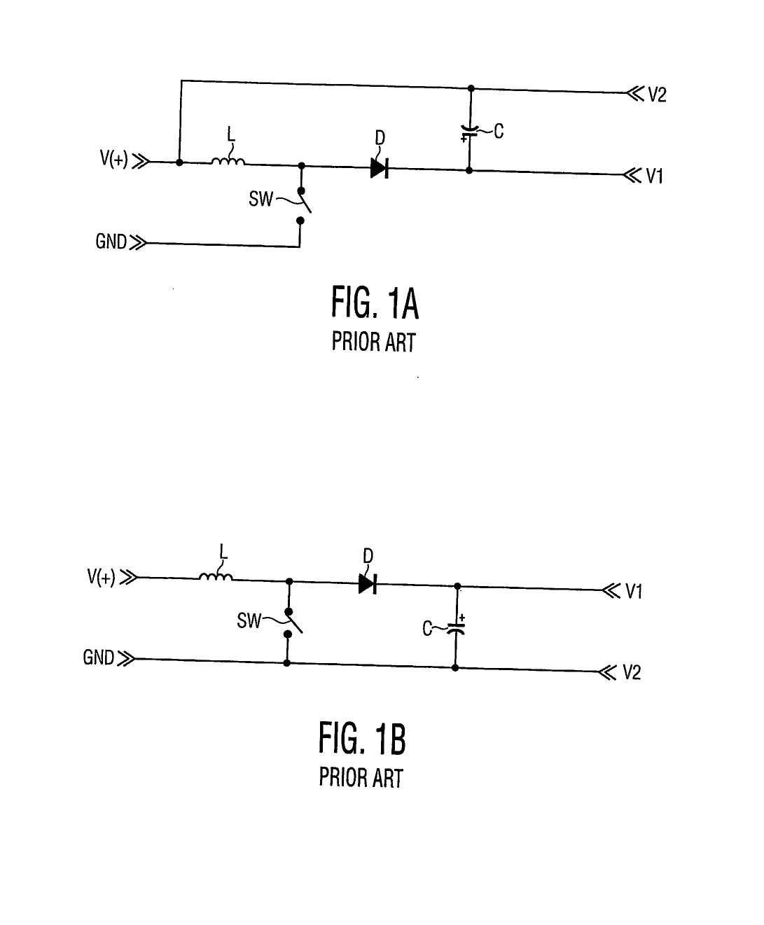

One such switching regulator is the flyback regulator. FIG. 1A is a schematic diagram illustrating a conventional embodiment of a flyback regulator circuit. The flyback regulator circuit functions within either of two states. A first state occurs when switch SW is in a closed position (Sₒₙ). A second state occurs when switch SW is in an open position (S_{off}). The total amount of time to complete the first and second state is a cycle time [(Sₒₙ)+(S_{off})].

When switch SW is in a closed position, input voltage from input voltage terminal V(+) flows through inductor L, in the form of current, and through switch SW to ground GND. Current flowing into inductor L, results in the inductor storing energy. At some point, the second state occurs and switch SW opens.

When switch SW opens, the stored energy within inductor L flows out the inductor in the form of current. The current flows through diode D and into capacitor C. The system gain can be expressed as follows:
H(s)=(V₂−V₁)/V(+)=D/(1−D)
where D is the duty-cycle defined as the (Sₒₙ)/[(Sₒₙ)+(S_{off})].

In this circuit, an output voltage at output voltage terminal V₂ relative to an output voltage at output voltage terminal V₁ is controlled. Unfortunately, the output voltage at output voltage terminal V₂ relative to ground GND is very high. This effect is due to the output voltage at output voltage terminal V₂ equaling the sum of the output voltage at output voltage terminal V₁ relative to ground GND and the output voltage at output voltage terminal V₂ relative to the output voltage at output voltage terminal V₁.

For example, if input voltage at input voltage terminal V(+) were 480V AC rectified (peak 680 V DC) and the output voltage at output voltage terminal V₂ relative to the output voltage at output voltage terminal V₁ would be approximately 480V DC. Therefore, the output voltage at output voltage terminal V₂ relative to ground GND would be approximately 1200V DC, almost double that of the input voltage at input voltage terminal V(+). Unfortunately, switch S₁ would need to be rated to handle the high voltage. Such a switch is generally cost prohibitive.

Additionally, the high relative voltage results in high dielectric breakdown issues in components within the system and safety issues involved with utilizing such high voltages. Therefore, this type of regulator is generally not considered for high input voltage applications.

Another conventional regulator is illustrated in FIG. 1B. FIG. 1B is a schematic diagram illustrating a boost regulator circuit designed for lower voltage applications. The boost regulator circuit of FIG. 1B also functions within either of two states, similar to the flyback regulator of FIG. 1A. A first state occurs when switch SW is in a closed position (Sₒₙ). A second state occurs when switch SW is in an open position (S_{off}). The total amount of time to complete the first and second state is called a cycle time [(Sₒₙ)+(S_{off})].

Typically, voltage increases in the boost regulator circuit of FIG. 1B are approximately 50 V DC. For example, if input voltage at input voltage terminal V(+) were 277V AC rectified (peak 390 V DC), the output voltage at output voltage terminal V₂ relative to the output voltage at output voltage terminal V₁ would be approximately 480V DC. In this example, a 600 V DC rated switch would be utilized for switch SW. 600 V DC rated switches are readily available and economical to utilize. Unfortunately, the boost regulator circuit of FIG. 1B requires a low voltage input and increases the voltage output. For example, a 480V AC rectified input would produce an 800V DC output. Such a high voltage is impractical to utilize in electronic applications.

It would be desirable, therefore, to provide an apparatus and method that would overcome these and other disadvantages.

One aspect of the invention provides an apparatus that regulates a step-down voltage across a load. The apparatus includes a regulator circuit arranged to couple power from an unregulated power supply to the load in response to a control signal. The apparatus additionally includes a power control circuit arranged to selectively couple power from the unregulated power supply to the regulator circuit when activated by the control signal.

In accordance with another aspect of the invention, the invention provides a method for operating a switching regulator at reduced power. The method includes closing a first switch responsive to a first control signal wherein power is directed to a regulation circuit. The method further includes directing power to ground in the regulation circuit by closing a second switch simultaneous to the closing of the first switch. The method additionally includes opening the first switch responsive to a second control signal, wherein power is disconnected from the regulation circuit. The method further includes supplying power to a load by opening the second switch simultaneous to the opening of the first switch.

In accordance with another aspect of the invention, the invention provides a system for operating a switching regulator at reduced power. The system includes means for closing a first switch responsive to a first control signal wherein power is directed to a regulation circuit. The system further includes means for directing power to ground in the regulation circuit by closing a second switch simultaneous to the closing of the first switch. The system additionally includes means for opening the first switch responsive to a second control signal, wherein power is disconnected from the regulation circuit. The system further includes means for supplying power to a load by opening the second switch simultaneous to the opening of the first switch.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

FIG. 1A is a schematic diagram illustrating a conventional embodiment of a flyback regulator circuit;

FIG. 1B is a schematic diagram illustrating a conventional embodiment of a boost regulator circuit;

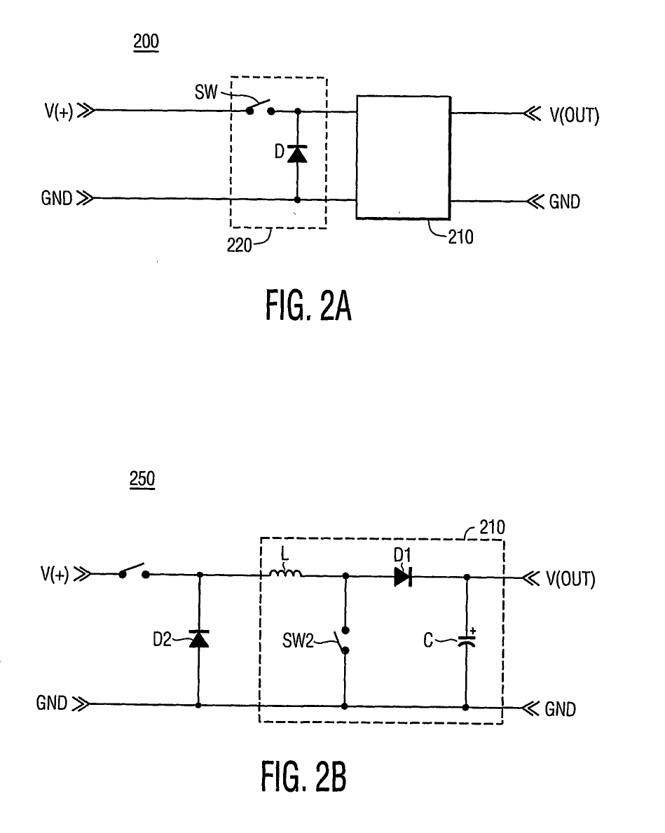

FIG. 2A is a schematic diagram illustrating a regulator circuit according to an embodiment of the present invention;

FIG. 2B is a schematic diagram illustrating a regulator circuit according to another embodiment of the present invention;

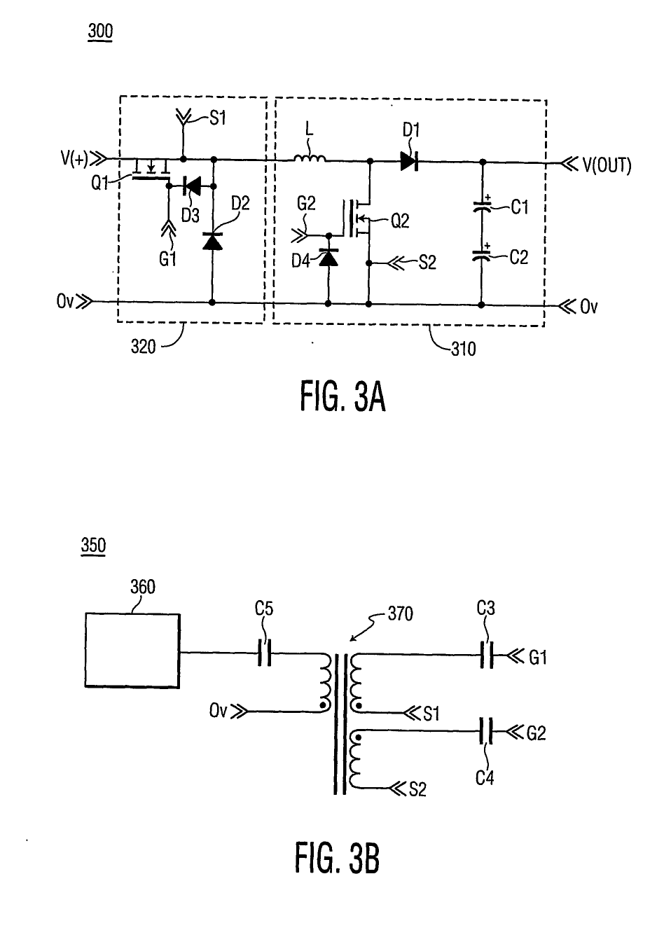

FIG. 3A is a schematic diagram illustrating a regulator circuit according to yet another embodiment of the present invention; and

FIG. 3B is a schematic diagram illustrating a control signal generator according to an embodiment of the present invention.

Throughout the specification, and in the claims, the term “connected” means a direct physical connection between the things that are connected, without any intermediate devices. The term “coupled” means either a direct physical connection between the things that are connected, or an indirect connection through one or more passive or active intermediary devices. The term “circuit” means either a single component or a multiplicity of components, either active or passive, that are coupled together to perform a desired function.

FIG. 2A is a schematic diagram illustrating regulator circuit 200, according to an embodiment of the present invention. The regulator circuit 200 includes boost regulator circuit 210, power control circuit 220, input voltage terminal V(+), output voltage terminal V(Out), and circuit ground terminal GND. Power control circuit 220 includes diode circuit D and switch circuit SW.

Boost regulator circuit 210 is coupled to input voltage terminal V(+), output voltage terminal V(Out), and a circuit ground terminal GND associated with each voltage terminal. In one embodiment, boost regulator circuit 210 is implemented as detailed in FIG. 1B above.

Switch circuit SW, of power control circuit 220, is coupled between boost regulator circuit 210 and input voltage terminal V(+). Diode circuit D, of power control circuit 220, includes a cathode coupled to Switch circuit SW and boost regulator circuit 210, and an anode coupled to circuit ground terminal GND. Diode circuit D is coupled in parallel with boost regulator circuit 210.

In operation and detailed in FIG. 21 below, power control circuit 220 is arranged to selectively couple power from an unregulated power supply, which provides voltage to input voltage terminal V(+), to the boost regulator circuit 210 when activated by a control signal.

FIG. 2B is a schematic diagram illustrating regulator circuit 250, according to an embodiment of the present invention. The regulator circuit 250 includes boost regulator circuit 210, diode circuit D₂, switch circuit SW₁, input voltage terminal V(+), output voltage terminal V(Out), and circuit ground terminal GND.

Boost regulator circuit 210 includes inductor L, capacitor C, diode circuit D₁, and switch circuit SW₂. Boost regulator circuit 210 is configured as a conventional boost regulator circuit, such as, for example the boost regulator circuit of FIG. 1B above.

Switch circuit SW₁, is coupled between boost regulator circuit 210 and input voltage terminal V(+). Diode circuit D₂ is coupled in parallel with boost regulator circuit 210. Diode circuit D₂ includes a cathode coupled to Switch circuit SW₁ and boost regulator circuit 210, and an anode coupled to circuit ground terminal GND.

In operation, switch circuit SW₁ and switch circuit SW₂ operate in tandem. For example, when switch circuit SW₁ closes in response to a control signal, switch circuit SW₂ closes simultaneously. In one embodiment, the control signal is a periodic control signal. In an example, the control signal is a periodic mutli-state control signal.

In this example, the control signal is a periodic control signal having a first state when switch circuits (SW₁ and SW₂) are in a closed position (Sₒₙ) and a second state occurs when switch circuits SW₁ and SW₂ are in an open position (S_{off}). The total amount of time to complete the first and second state is a cycle time [(Sₒₙ)+(S_{off})].

When the control signal operates within the first state, the signal causes switch circuits (SW₁ and SW₂) to operate in the closed position (Sₒₙ). When switch circuits (SW₁ and SW₂) operate in the closed position (Sₒₙ), a circuit path is formed from input voltage terminal V(+), thru inductor L, and to ground terminal GND. Power, in the form of voltage, is applied to input voltage terminal V(+) and is supplied to inductor L, in the form of current. Inductor L stores the received current.

When the control signal operates within the second state, the signal causes switch circuits (SW₁ and SW₂) to operate in the open position (S_{off}). When switch circuits (SW₁ and SW₂) operate in the open position (S_{off}), a circuit path is formed from inductor L, thru diode circuit D₁, into capacitor C, to ground terminal GND, and thru diode circuit D₂. Power, in the form of current, is supplied from inductor L to capacitor C. Capacitor C stores the received power as voltage.

The voltage gain of the system can be expressed as follows:
H(s)=V(Out)/V(+)=D/(1−D)
where D is the duty-cycle defined as the (Sₒₙ)/[(Sₒₙ)+(S_{off})].

The system characteristics are substantially similar to the flyback regulator characteristics in FIG. 1A above. However, the voltage output of the improved regulator circuit 250 shares a common return ground terminal (GND) as the input voltage.

FIGS. 3A and 3B represent a preferred implementation of a regulator circuit and a control signal generator circuit. FIG. 3A is a schematic diagram illustrating regulator circuit 300, according to yet another embodiment of the present invention. The regulator circuit 300 includes boost regulator circuit 310, power control circuit 320, input voltage terminal V(+), output voltage terminal V(Out), and circuit ground terminal GND. Like components from FIGS. 2B and 3A are labeled and function substantially similarly.

Boost regulator circuit 310 includes inductor L, capacitors C₁ and C₂, transistor Q₂, and diode circuits D₁ and D₄. Transistor Q₂ and diode circuit D₄ perform the function of switch circuit SW₂ illustrated in FIG. 2B above.

Power control circuit 320 includes transistor Q, and diode circuits D₂ and D₃. Transistor Q₁ and diode circuit D₃ perform the function of switch circuit SW₁ illustrated in FIG. 2B above. Transistors (Q₁ and Q₂) may be implemented as any suitable transistors, such as, for example MOSFET transistors or BJT transistors.

Transistor Q₁ includes a source coupled to inductor L of the flyback regulator circuit 310 and a signal generator via source connection S₁, a drain coupled to the unregulated power supply via input voltage terminal V(+), and a gate coupled to the signal generator via gate connection G₁. Diode circuit D₃ includes a cathode portion coupled to the gate of transistor Q₁ and an anode portion coupled to inductor L and the cathode portion of diode circuit D₂. In one embodiment, transistor Q₁ is implemented as a 800 V switch.

Transistor Q₂ includes a source coupled to circuit ground terminal GND via source connection S₂, a drain coupled to inductor L and an anode portion of diode circuit D₁, and a gate coupled to the signal generator via gate connection G₂. Diode circuit D₄ includes a cathode portion coupled to the gate of transistor Q₂ and an anode portion coupled to circuit ground terminal GND. In one embodiment, transistor Q₁ is implemented as a 600 V switch.

FIG. 3B is a schematic diagram illustrating a control signal generator circuit 350, according to an embodiment of the present invention. Control signal generator circuit 350 includes a control signal generator 360 coupled to a transformer 370, in-line capacitor C₅, and a circuit ground terminal GND.

In one embodiment, control signal generator 360 is implemented as an 8-pin power factor control (PFC) chip, such as, for example a PWM Chip L6561 manufactured by ST Microelectronics of San Diego, Calif. Transformer 370 is implemented as a duel secondary pulse transformer.

Transformer 370 includes a primary winding and two secondary windings. Each secondary winding includes a gate connection (G₁ and G₂) with an in-line capacitor (C₃ and C₄), and a source connection (S₁ and S₂). In one embodiment, the secondary windings are implemented with in phase polarity allowing both transistors (Q₁ and Q₂) to function simultaneously. In an example, when the secondary windings are implemented with the same polarity, each transistor and associated gate diode (D₃ and D₄) function substantially similar as switch circuits (SW₁ and SW₂) illustrated in FIG. 2B above.

In this embodiment, control signal generator 360 produces a two state control signal sufficient to operate regulator circuit 300. The regulator circuit 300 produces desirable output voltage with acceptable power factor rating and minimal harmonic distortion. Table 1 includes relevant data achieved utilizing improved regulator circuit 300 and controlled by control signal generator circuit 360.

TABLE 1

| | | | |
|---|---|---|---|
| 347 V AC input | 120 W input | 0.997 power factor | 5% harmonic |
| 465 V DC output | | | distortion |
| 347 V AC input | 63 W input | 0.94 power factor | 8.3% harmonic |
| 465 V DC output | | | distortion |
| 480 V AC input | 120 W input | 0.992 power factor | 6.6% harmonic |
| 465 V DC output | | | distortion |
| 480 V AC input | 62 W input | 0.976 power factor | 8.3% harmonic |
| 465 V DC output | | | distortion |

As illustrated in Table 1 and FIG. 3A, the regulator circuit 300 utilizes switching circuits that are readily available as well as economical. Furthermore, regulator circuit 300 can produce an output voltage lower than the input voltage including an acceptable power factor and low harmonic distortion.

The switching cycle produced by the present invention, when controlled by an industry standard power factor correction integrated circuit can be utilized to generate a low output voltage from a high input voltage and posses an additional attribute of reducing harmonic currents to acceptable values.

The above-described apparatus and method for producing a regulated power output utilizing a two-switch configuration are example methods and implementations. These methods and implementations illustrate one possible approach for producing a regulated power output utilizing a two-switch configuration. The actual implementation may vary from the method discussed. Moreover, various other improvements and modifications to this invention may occur to those skilled in the art, and those improvements and modifications will fall within the scope of this invention as set forth in the claims below.

The present invention may be embodied in other specific forms without departing from its spirit or essential characteristics. The described embodiments are to be considered in all respects only as illustrative and not restrictive.

1. An apparatus that regulates a voltage across a load, the apparatus comprising:
a regulator circuit (210, 310) is arranged to couple power from an unregulated power supply V(+) to the load V(Out) in response to a control signal; and
a power control circuit (220, 320) is arranged to selectively couple power from the unregulated power supply V(+) to the regulator circuit (210, 310) when activated by the control signal.

2. The apparatus of claim 1, wherein the regulator circuit (210, 310) is a boost regulator circuit.

3. The apparatus of claim 1, wherein the control signal is a periodic control signal.

4. The apparatus of claim 1, wherein the power control circuit comprises:
a switch circuit (SW, SW₁) is arranged to selectively couple power from the unregulated power supply V(+) to the regulator (210, 310) when activated by the control signal; and
a diode circuit (D, D₂) is arranged in parallel to the regulator circuit (210, 310) wherein the diode circuit (D, D₂) provides a closed loop path responsive to the control signal.

5. The apparatus of claim 4 wherein the switch circuit (SW, SW₁) is selected from a group consisting of: a MOSFET transistor and a BJT transistor.

6. The apparatus of claim 4 wherein the diode circuit (D, D₂) is a diode.

7. The apparatus of claim 4, wherein the switch circuit comprises:
a MOSFET transistor Q₁ having a source S₁ operably coupled to the regulator circuit 310 and a signal generator 350, a drain operably coupled to the unregulated power supply V(+), and a gate G1 operably coupled to the signal generator 350; and
a diode circuit D₃ having a cathode portion operably coupled to the gate G₁ of the metal oxide semiconductor transistor Q₁ and an anode portion operably coupled to the regulator circuit 310.

8. The apparatus of claim 7 wherein the diode circuit D₃ is a diode.

9. A method for operating a switching regulator, comprising:
closing a first switch SW₁ responsive to a first control signal, wherein power is directed to a regulation circuit 310;
directing power to ground in the regulation circuit 310 by closing a second switch SW₂ simultaneous to the closing of the first switch SW₁;
opening the first switch SW₁ responsive to a second control signal, wherein power is disconnected from the regulation circuit 310; and
supplying power by opening the second switch SW₂ simultaneous to the opening of the first switch SW₁.

10. The method of claim 9, wherein the regulator 310 is operated with reference to ground GND.

11. The method of claim 9, wherein supplying power comprises:
supplying an output voltage V(Out) that is less than an input voltage V(+) supplied by an unregulated power supply.

12. A system for operating a switching regulator (200, 250, 300), comprising:
means for coupling power from an unregulated power supply V(+) to a regulation circuit (210, 310) responsive to a first control signal; and
means for coupling stored power in the regulation circuit (210, 310) to a load V(Out) responsive to a second control signal.
